(19) United States
(12) Patent Application Publication
(10) Pub. No.: US 2025/0074005 A1
(43) Pub. Date: Mar. 6, 2025

(54) METHOD FOR IMPROVING ABSORPTION OF DROPLETS ON POWDER

(71) Applicant: BRIGHAM YOUNG UNIVERSITY, Provo, UT (US)

(72) Inventors: Nathan Crane, Vineyard, UT (US); Colton Inkley, South Jordan, UT (US)

(73) Assignee: BRIGHAM YOUNG UNIVERSITY, Provo, UT (US)

(21) Appl. No.: 18/818,559

(22) Filed: Aug. 28, 2024

Related U.S. Application Data
(60) Provisional application No. 63/534,890, filed on Aug. 28, 2023.

(51) Int. Cl. B29C 64/393; B22F 10/14; B22F 10/50; B22F 10/85; B22F 12/90; B28B 1/00; B28B 17/00; B29C 64/165; B33Y 10/00; B33Y 50/02

(52) U.S. Cl. CPC B29C 64/393; B22F 10/14; B22F 10/50; B22F 10/85; B22F 12/90; B28B 1/001; B28B 17/0081; B29C 64/165; B33Y 10/00; B33Y 50/02

(57) ABSTRACT

Disclosed is a rigidity measuring device comprising an arm. The arm includes a rail and a base connected to the rail. The rail includes a limit switch, and the base includes a load cell. Also, disclosed is a rigidity measuring device comprising an arm and a processor. The arm includes a rail and a base connected to the rail. The rail includes a limit switch, and the base includes a load cell. The processor electronically connects to the limit switch and the load cell.

This application claims the priority and benefit of U.S. Provisional Patent Application No. 63/534,890 filed on Aug. 28, 2023, which is incorporated by reference in its entirety.

### BACKGROUND

Binder jetting is a form of additive manufacturing that has significantly evolved since its inception in the early 1990s. This technology, which involves the selective deposition of a liquid binding agent onto a bed of powder material to create solid structures layer by layer, has its roots in both the advancements in 3D printing technologies and powder metallurgy.

The concept of additive manufacturing, where objects are built layer by layer, began gaining traction in the early 1980s. Technologies such as stereolithography (“SLA”) and selective laser sintering (“SLS”) emerged as pioneers in the field. However, these early methods primarily involved the use of lasers to cure or fuse materials, which limited the types of materials that could be used and the range of applications.

The invention of binder jetting is credited to researchers at the Massachusetts Institute of Technology (“MIT”), particularly to Professor Ely Sachs and his team. In 1993, Sachs and his colleagues developed a new method of 3D printing that differed significantly from existing technologies. Instead of using a laser or other energy source to fuse or cure material, they proposed the use of a liquid binder that could selectively bind powder particles together. This method, initially referred to as “Three-Dimensional Printing”, involved spreading a thin layer of powdered material onto a build platform, followed by the selective deposition of binder material in the desired pattern for that layer. The process would be repeated layer by layer, with the binder acting to glue the powder particles together in the regions where solid material was desired. Once the printing process was complete, the unbound powder could be removed, leaving behind the final object.

MIT's innovation was groundbreaking because it allowed for the use of a wide variety of materials, including metals, ceramics, and even sand. The ability to use different powders and binders opened up new possibilities for manufacturing, particularly in industries where material properties such as porosity, thermal resistance, or biocompatibility were critical. Following the invention of binder jetting, MIT licensed the technology to several companies, leading to its commercialization. Z Corporation (later acquired by 3D Systems) was one of the first companies to develop and market binder jetting machines. Their early systems were primarily used for prototyping, allowing designers to quickly create models and iterate on designs before moving to full-scale production.

During the late 1990s and 2000s, binder jetting began to gain traction in various industrial applications. Its ability to produce parts with complex geometries, internal structures, and a wide range of material properties made it particularly attractive to industries such as automotive, aerospace, and healthcare. The 2010s saw significant advancements in binder jetting technology, driven by improvements in material science, software, and hardware. New binders were developed that could work with a broader range of powders, including those that were previously challenging to print, such as certain metals and ceramics. Additionally, advancements in inkjet technology allowed for more precise control over binder deposition, leading to higher resolution and better surface finishes.

Other companies began to push the boundaries of what binder jetting could achieve, moving the technology from prototyping into full-scale production. These advancements included the development of post-processing techniques like sintering and infiltration, which improved the mechanical properties and density of printed parts. The introduction of multi-material binder jetting systems further expanded the capabilities of the technology, allowing for the creation of parts with varying material properties in different regions of the same object. This development was particularly important in applications requiring parts with complex mechanical or thermal gradients.

Today, binder jetting is recognized as a versatile and cost-effective additive manufacturing technology with applications across a wide range of industries. Its ability to produce large parts, multiple parts simultaneously, and use a diverse set of materials makes it an attractive option for both prototyping and production. However, binder jetting suffers from reduced mechanical properties compared to more traditional manufacturing methods. The reduction is due to process-related porosity and low green part density. As binder jetting parts are sintered, shrinkage occurs and can often cause deformation in unsupported regions. Predicting and compensating for deformations in the printed parts is an area of active research. Binder jetting is also a poor process for thin or fine parts. Although the parts could be effectively printed it becomes difficult to extract from the powder and transfer due to the fragile nature of green parts.

The basic physics behind binder jetting part formation is the interaction between binder and powder. Every aspect of binder jetting ensures that a droplet of binder disperses into a region of powder and increases cohesive forces between particles. During printing, millions of small droplets moving at a high rate of speed impact the powder. Varying wetting physics, depending on the different binder and powder properties, adds complexity. The interaction between powder and binder is complex and poorly comprehended, but understanding it is critical to binder jetting advancement.

### SUMMARY OF THE DISCLOSURE

Disclosed herein is a method and a system for improving the absorption of droplets on powder.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a method for improving the absorption of droplets on powder.

FIG. 2 illustrates a schematic diagram of improving the absorption of droplets on powder.

FIG. 3 illustrates a side view of a system for improving the absorption of droplets on powder.

FIG. 4 illustrates a perspective view of a system for improving the absorption of droplets on powder.

FIG. 5 illustrates a side view of a system for improving the absorption of droplets on powder.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

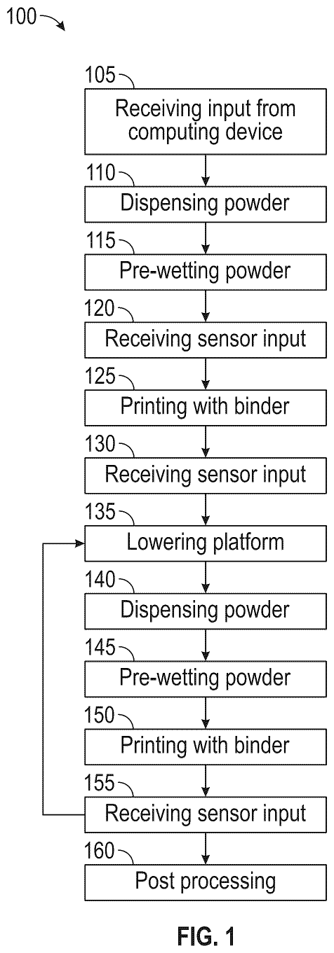

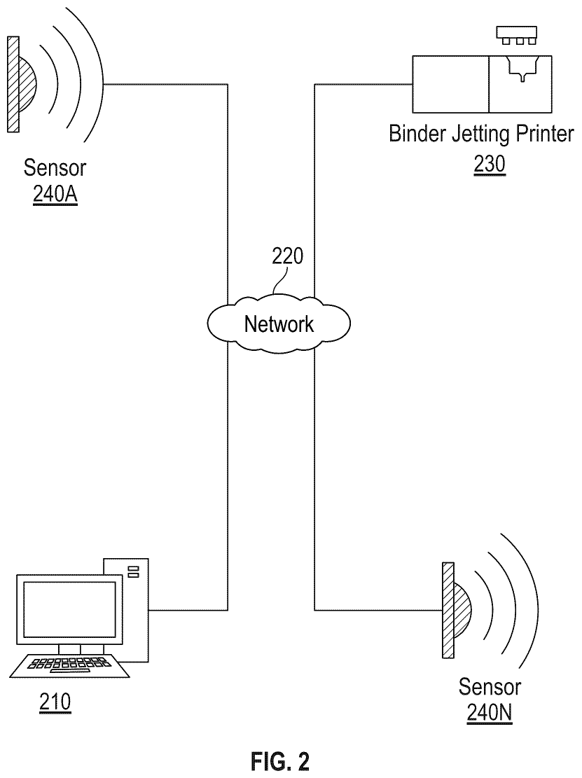

FIG. 1 illustrates method 100 for improving the absorption of droplets on powder. Method 100 may include step 105 of receiving input from a computing device (210 as depicted in FIG. 2) by the binder jetting printer (230 as depicted in FIG. 2). This input may include various parameters needed to manufacture the object such as a layer-by-layer design of the object to be printed. This input may also include when, in the process, the binder jetting printer is to be receiving sensor input 125 and/or 150 and what to do based on the sensor input received.

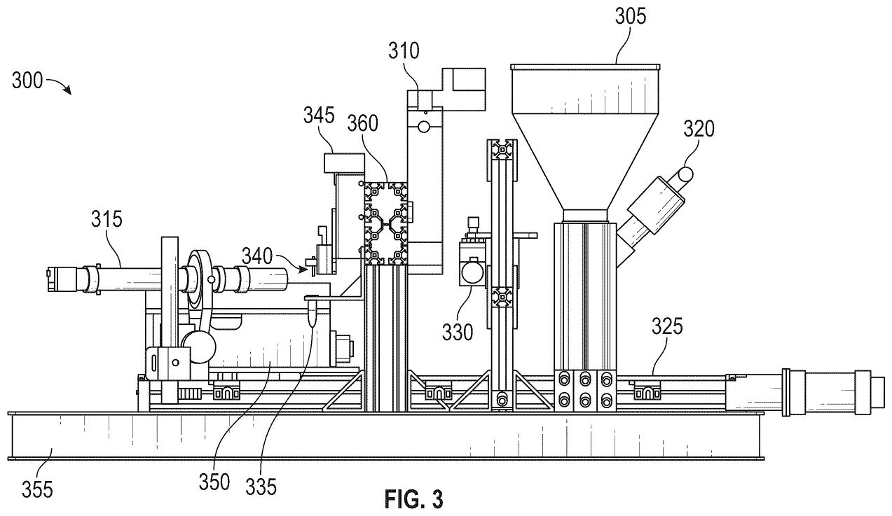

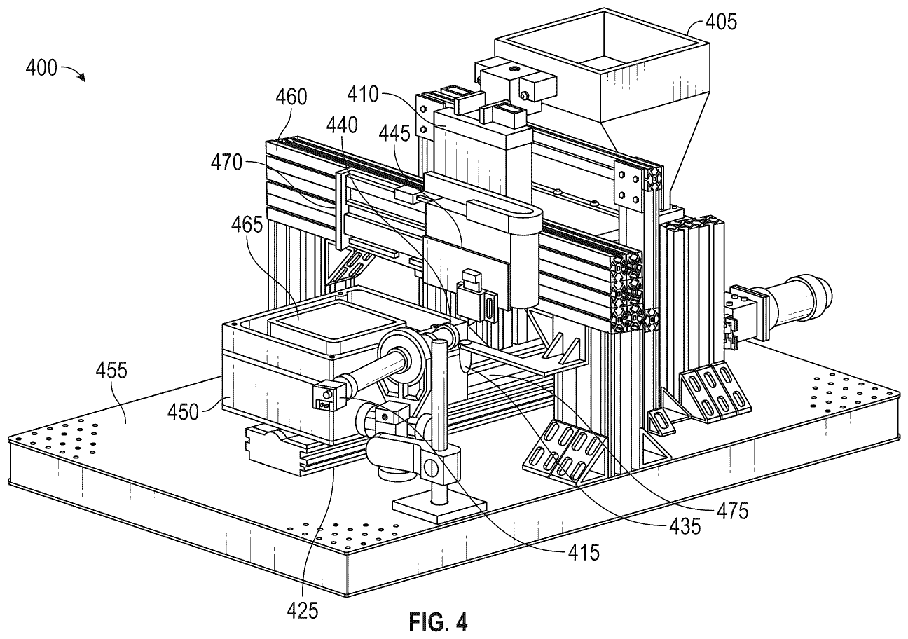

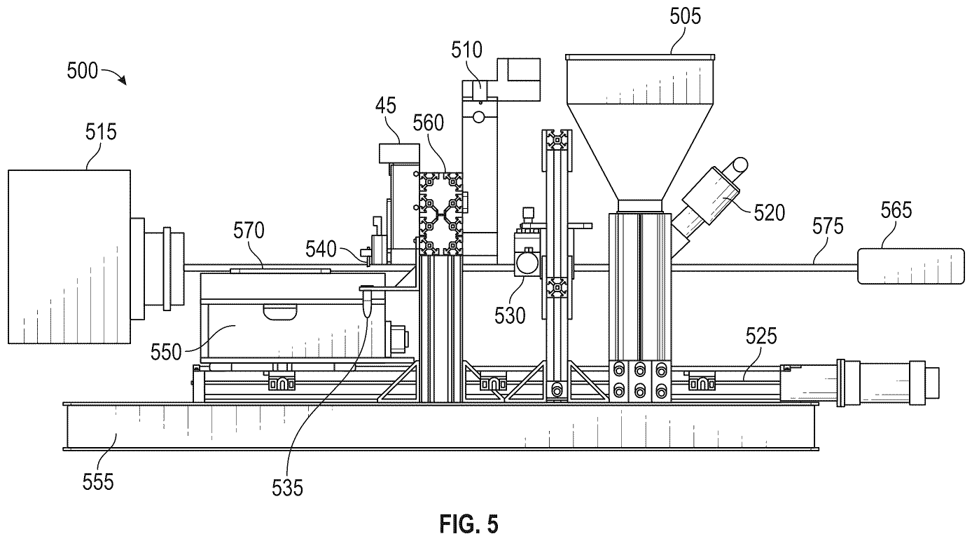

Step 110 may include dispensing the powder. Dispensing the powder in step 110 includes creating a uniform thickness by using a coating mechanism such as a roller (similar to 330 or 530 depicted in FIGS. 3 and 5 respectively) or a blade, to spread a thin layer of powder from a powder reservoir onto the build platform (similar to 465 and 570 as seen in FIGS. 4 and 5 respectively). The thickness of this layer typically ranges from a few microns to several millimeters, depending on the desired resolution and material. The powder may consist of sand, metal powder, ceramic powder, polymer powder, composite powder, biomaterial powder, or other powders known in the art.

After the thickness of the powder has been set step 115 of pre-wetting the powder may occur. Various methods of pre-wetting the powder may be used such as the timing of the application, the process of application, and the type of liquid used in the application. The timing of pre-wetting may occur prior to step 110 dispensing of the powder, after step 110 but before printing with binder in step 120, during step 120, or after step 120. The process of pre-wetting may include spraying (using a moisture delivery unit such as a Piezoelectric atomizer), vapor exposure, or humidity controlling. Other methods may be used in place of or in combination with pre-wetting. These methods may include pre-heating the powder reducing the viscosity of the binding agent or including additives into the powder enhancing their wettability when exposed to another form of application. One or more of these methods may be used to seek the desired results.

The powder may be pre-wetted by a variety of liquids such as water, organic solvent (e.g., alcohol), diluted binder solutions, surfactant solution, and humectant (e.g., Tri ethylene glycol). These different liquids can serve different purposes depending on what powder is used and what object is being manufactured. The type of liquid added is important but also the amount of liquid added is also important. For example, the moisture levels of the powder may be between 0.021 mg/cm² to 0.1225 mg/cm². Also, moisture levels closer to 0.021 mg/cm² may be preferable. Various sensors may be used to monitor the pre-wetting process such as an imaging sensor, weight sensor, or a moisture sensor. Step 120 may occur at the same time as step 120, or after step 120 so that imaging or weight sensors can monitor the liquid droplets coming from the nozzles of the moisture delivery unit. The imaging sensor (as depicted in 315, 415, 515, and 565 in FIGS. 3, 4, and 5 respectively) may be used to monitor the application process. The weight sensor may be used to monitor the amount of liquid applied and the rate of evaporation of the liquid from the powder. The moisture sensor can monitor the moisture content of the powder.

After pre-wetting the powder in step 115 method 100 may include printing with the binder in step 125. This may include positioning the print head over the powder. The print head may include a series of nozzles that selectively deposit a liquid binding agent onto specific areas of the powder layer, corresponding to a cross-section of the object being printed as provided by a computing device in step 105. Further, the printer may apply the binder selectively to the powder layer, binding the powder particles together in the desired pattern. The areas where the binder is applied may form the solid structure of the part. Adjustments to the printing may be made depending on the information received from one or more sensors.

Step 130 may occur at the same time as step 125, or after step 125 so that imaging sensors can monitor the liquid droplets coming from the nozzles of the binder jetting printer. The type of nozzles used may include one or more of the following types of nozzles, piezoelectric, thermal (“bubble jet”), value jet, continuous inkjet, microwave nozzles, and other nozzles known in the art. Liquid droplets from the printer head may cause a disturbance in the powder. For example, a droplet usually consists of a head and a tail. However, if the head separates from the tail, the tail creates a satellite droplet that can further disturb the powder. If this separation occurs sensor information monitoring this process may be relayed to the binder jetting printer to make adjustments.

Imaging sensors used may include but are not limited to cameras, x-rays, scanning electron microscopes, laser scanners, thermal cameras, confocal microscopes, ultrasonic equipment, computer tomography scanning (“CT”), optical coherence tomography (OCT), and white light interferometry. Imaging sensors may be used not only to monitor the ejection of binder solution but also the quality of the object being printed. Disturbances in printing, such as satellite droplets, can create a rough surface and/or balling in the powder that when combined with different layers may create pockets, pores, and/or unwanted roughness in or on the object being printed. Imaging sensors may be used to determine the quality of the printed object and relay imaging information to a computing device to make adjustments in real time.

In step 135 after the printing occurs the platform may lower in preparation for more powder. After the platform is lowered the powder may include dispensing powder in step 140. Powder using a recoating mechanism (such as a roller or blade), may spread a thin layer of powder distributed from a powder reservoir onto the build platform ranging from a few microns to several millimeters, depending on the desired resolution and material. After the powder was dispensed in step 140 the pre-wetting of the powder may take place in step 145. Printing with the binder follows in step 150. Receiving sensor input may take place in step 155. Imaging sensors may be used to monitor the effect of the binder droplets on the powder and/or the printed object and relay information that may include the image or may include a requested adjustment to a network or directly to a computing device or binder jetting printer. The cyclical pattern between 135 may repeat until the object being printed is completed. Step 160 post-processing may occur. Post-printing processing, in step 160, may include removing the printed object from the powder. Excess powder is often left around the object to support it during the build and is removed after printing. This may also include cleaning the object to remove any loose, unbound powder. This can involve brushing, air blasting, or using a vacuum. Optionally, additional post-processing steps may be performed, such as sintering (for metal parts), infiltrating with another material (such as resin or metal), or applying surface treatments to enhance the mechanical properties, appearance, or functionality of the part. Step 160 of the post-procedure may include further imaging by an imaging sensor to assess the object. Imaging sensors may include but are not limited to a camera, high-speed camera, high-speed x-ray, scanning electron microscope (“SEM”)

FIG. 2 illustrates a schematic diagram of system 200 improving the absorption of droplets on powder. System 200 may include cloud network 220, computing device 210, sensor 240A, binder jetting printer 230, and one or more sensors 240N. These devices 210, 230, 240A, and 240N may communicate directly or via a cloud network 220.

Computing devices 210 may include the series of tasks needed to produce a 3D object. This includes information on the dimensions of the particular 3D object, the slicing information, the printing parameters, the material data, the support structures, and the printing calibration and configuration needed. Computing device 210 may be able to receive and interpret input from one or more sensors 240A and 240N, either directly or through cloud network 220. Once input is received from one or more sensors 240A and 240N computing device 210 may be able to interpret the data be it an image or data and send updated printing parameters to binder jetting printer 230. Binder jetting printer 210 may include a processor to be able to receive and process input data directly or through cloud network 220. Computing device 210 may use machine learning such as artificial intelligence (“AI”) to adjust how to best react to information received from sensors 240A and 240N. Computing device 210 may store various sensors from sensors 240A and 240N including the results of reactions to the sensor readings and how they affected the production of the 3D object.

Sensor 240A may be an imaging sensor (e.g., high-speed camera, high-speed x-ray, scanning electron microscope (“SEM”). Sensor 240A may be monitoring the binder as it is expelled in droplets from the printing mechanism and the interaction between the binder and the powder when they come in contact with each other. Sensor 240 while monitoring the droplets may look to see if the head of the droplets are being separated from their tails. The separation of the heads and tails of a droplet can create roughness and balling that can compromise the integrity of a 3D object being produced. In this way, both the cause and effect may be monitored by sensor 240A. Sensor 240A may communicate this information directly or through cloud network 220 to computing device 210. Sensor 240A may also send a suggested action to take such as increase or decrease binder droplet spacing or increase or decrease printer speed. Sensor 240N may be an optical device or may also be able to record ambient temperature, humidity, moisture, and weight of the build plate. One or more of sensors 240N may be included to aid in the computer learning of the system to improve the absorption of droplets on powder.

FIG. 3 illustrates a side view of system 300 improving the absorption of droplets on powder. System 300 may include hopper 305 which may be sized to receive and dispense powder. Attached to or near hopper 305 may be motor 320. Motor 320 may be an ultrasonic motor. Other types of motors may be used for motor 320 depending on the type of powder used and the design of the product at hand. Motors 320 may include but are not limited to stepper motors, servo motors, brushless DC motors (“BLDC”), geared motors, piezoelectric motors, and other motors known in the art. Arm 325 may provide the y-axis movement such that build box 350 may attach to hopper 305 to receive powder by activating motor 320.

System 300 may include roller 330 to help level out the powder after being positioned onto the build plate positioned within build box 350. Roller 330 may also be a blade or other leveling equipment known in the art. System 300 may also include moisture delivery unit 310. Moisture delivery unit 310 may be a piezoelectric atomizer to help moisten the powder. Moister delivery unit 310 may be attached to bridge 360. Bridge 360 may run perpendicularly to arm 325. Bridge 360 may also attach to binder printer 345 which may be able to move back and forth along bridge 360 along the x-axis. Binder printer 345 may be connected to binder collection unit 335 where the binder mixture may be loaded into a storage container within binder printer 345. Binder printer 345 may include nozzle 340. Nozzle 340 may be used to dispense the binder mixture onto the build place positioned within build box 350. Nozzle 340 may include one or more of the following types of nozzles, piezoelectric, thermal (“bubble jet”), value jet, continuous inkjet, microwave nozzles, and other nozzles known in the art. System 300 may focus more on the piezoelectric nozzle to use as nozzle 340 however, system 300 may function using one or more.

System 300 may also include imaging sensor 315. Imaging sensor 315 may be one or more optical cameras (including high-speed cameras), x-rays, scanning electron microscopes, laser scanners, thermal cameras, confocal microscopes, ultrasonic equipment, computer tomography scanning (“CT”), optical coherence tomography (OCT), white light interferometry, and other imaging sensors known in the art. Imaging sensor 315 may attach to base 355 in a way that allows imaging sensor 315 to swivel to capture the movement of printer motor 345 as it moves back and forth along the x-axis. Alternatively, imaging sensor 315 may be fixed to base 355 or attached to build box 350 or to printer motor 345.

System 300 may be set up so that arm 325 may include a track that allows build box 350 to move back and forth along the y-axis. At the same time, bridge 360 may also include a track that allows printer motor 345 to move back and forth along the x-axis. The other devices may be attached to base 355 in a fixed position. In this exemplary setup build box 350 may move along a track disposed in arm 325 to be positioned under hopper 305 to receive a disbursement of powder. After, build box 350 may move across roller 330 leveling out the powder. Following roller 330 build box 350 may pass under moisture delivery unit 310 to receive by spray or mist the liquid used to moisten the powder. For example, the liquid may be a tri-ethylene glycol solution. After the powder is moistened build box 350 may move under the printer motor and move along the y-axis as the printer motor moves back and forth along the x-axis dispersing binding solution onto the powder. Both build box 350 and printer motor are moving imaging sensor 315 to be able to make an adjustment either in real-time or after the process is complete.

FIG. 4 illustrates a side view of system 400 that may be used for improving the absorption of droplets on powder with multiple imaging sensors 415 and 465. System 400 may include hopper 405 which is sized to receive and dispense powder. Attached to or near hopper 405 may be motor 420. Motor 420 may be an ultrasonic motor. Other types of motors may be used for motor 420 depending on the type of powder used and the design of the product at hand. Motors 420 may include but are not limited to stepper motors, servo motors, brushless DC motors (“BLDC”), geared motors, piezoelectric motors, and other motors known in the art. Arm 425 may provide the y-axis movement such that build box 450 may attach to hopper 405 to receive powder by activating motor 420.

System 400 may include roller 430 to help level out the powder after being positioned onto the build plate positioned within build box 450. Roller 430 may also be a blade or other leveling equipment known in the art. System 400 may also include moisture delivery unit 410. Moisture delivery unit 410 may be a piezoelectric atomizer to help moisten the powder. Moister delivery unit 410 may be attached to bridge 460. Bridge 460 may run perpendicularly to arm 425. Bridge 460 may also attach to binder printer 445 which may be able to move back and forth along bridge 460 along the x-axis. Binder printer 445 may be connected to binder collection unit 435 where the binder mixture may be loaded into a storage container within binder printer 445. Binder printer 445 may include nozzle 440. Nozzle 440 may be used to dispense the binder mixture onto the build place positioned within build box 450. System 400 may also include imaging sensor 415.

imaging sensor 415 may be one or more optical cameras (including high-speed cameras), x-rays, scanning electron microscopes, laser scanners, thermal cameras, confocal microscopes, ultrasonic equipment, computer tomography scanning (“CT”), optical coherence tomography (OCT), white light interferometry, and other imaging sensors known in the art. System 400 depicts imaging sensor 415 as a high-speed camera and x-ray device 465 emitting x-ray beam 475. Imaging sensor 415 may attach to base 455 fixed or in a way that allows imaging sensor 415 to swivel to capture the movement of printer motor 445 as it moves back and forth along the x-axis. Alternatively, imaging sensor 415 may attached to build box 450 or to printer motor 445.

System 400 may be set up so that arm 425 may include a track that allows build box 450 to move back and forth along the y-axis. At the same time, bridge 460 may also include a track that allows printer motor 445 to move back and forth along the x-axis. The other devices may be attached to base 455 in a fixed position. In this exemplary setup build box 450 may move along a track disposed in arm 425 to be positioned under hopper 405 to receive a disbursement of powder. After, build box 450 may move across roller 430 leveling out the powder. Following roller 430 build box 450 may pass under moisture delivery unit 410 to receive by spray or mist the liquid used to moisten the powder. For example, the liquid may be a tri-ethylene glycol solution. One or more imaging sensors 415 or 465 may be used to capture an image of the powder being moistened. After the powder is moistened build box 450 may move under the printer motor and move along the y-axis as the printer motor moves back and forth along the x-axis dispersing binding solution onto the powder. While both build box 450 and printer motor are moving imaging sensors 415 and 465 may be capturing the movement to detect absorption.

FIG. 5 illustrates a side view of system 500 that may be used for improving the absorption of droplets on powder. System 500 may include hopper 505 which is sized to receive and dispense powder. Attached to or near hopper 505 may be motor 520. Motor 520 may be an ultrasonic motor. Other types of motors may be used for motor 520 depending on the type of powder used and the design of the product at hand. Motors 520 may include but are not limited to stepper motors, servo motors, brushless DC motors (“BLDC”), geared motors, piezoelectric motors, and other motors known in the art. Arm 525 may provide the y-axis movement such that build box 550 may attach to hopper 505 to receive powder by activating motor 320.

System 500 may include roller 530 to help level out the powder after being positioned onto the build plate positioned within build box 550. Roller 530 may also be a blade or other leveling equipment known in the art. System 500 may also include moisture delivery unit 510. Moisture delivery unit 510 may be a piezoelectric atomizer to help moisten the powder. Moister delivery unit 510 may be attached to bridge 560. Bridge 560 may run perpendicularly to arm 525. Bridge 560 may also attach to binder printer 545 which may be able to move back and forth along bridge 560 along the x-axis. Binder printer 545 may be connected to binder collection unit 535 where the binder mixture may be loaded into a storage container within binder printer 545. Binder printer 545 may include nozzle 540. Nozzle 540 may be used to dispense the binder mixture onto the build place positioned within build box 350. System 500 may also include imaging sensor 515.

Imaging sensor 515 may be one or more optical cameras (including high-speed cameras), x-rays, scanning electron microscopes, laser scanners, thermal cameras, confocal microscopes, ultrasonic equipment, computer tomography scanning (“CT”), optical coherence tomography (OCT), white light interferometry, and other imaging sensors known in the art. Imaging sensor 515 may attach to base 555 in a way that allows imaging sensor 515 to swivel to capture the movement of printer motor 545 as it moves back and forth along the x-axis. Alternatively, imaging sensor 515 may be fixed to base 555 or attached to build box 550 or to printer motor 545. System 500 may also include an additional imaging sensor 565 which may be a high-speed x-ray. Sensors 565 and 515 may work simultaneously or one at a time.

System 500 may be set up so that arm 525 may include a track that allows build box 550 to move back and forth along the y-axis. At the same time, bridge 560 may also include a track that allows printer motor 545 to move back and forth along the x-axis. The other devices may be attached to base 555 in a fixed position. In this exemplary setup build box 550 may move along a track disposed in arm 525 to be positioned under hopper 505 to receive a disbursement of powder. After, build box 550 may move across roller 530 leveling out the powder. Following roller 530 build box 550 may pass under moisture delivery unit 510 to receive by spray or mist the liquid used to moisten the powder. For example, the liquid may be a tri-ethylene glycol solution. After the powder is moistened on build plate 570 may move under the printer motor and move along the y-axis as the printer motor moves back and forth along the x-axis dispersing binding solution onto the build plate 570. Both build box 550 and printer motor are moving imaging sensor 515 to be able to make an adjustment either in real-time or after the process is complete.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for improving the absorption of droplets on powder comprising:
receiving, by the binder jetting printer, input from a computing device,
dispensing, by the binder jetting printer, powder based,
pre-wetting, by the binder jetting printer, the powder with a liquid,
receiving, by the binder jetting, senor input based on pre-wetting the powder
printing with a binder, by the binder jetting printer, and
receiving, by the binder jetting printer, sensor input based on printing with a binder.

2. The method of claim 1, wherein the binder jetting printer uses moisture delivery unit to execute the pre-wetting of the powder.

3. The method of claim 2, wherein the moisture delivery unit is a Piezoelectric Atomizer.

4. The method of claim 1, wherein the liquid used in the pre-wetting of the powder is a humectant.

5. The method of claim 4, wherein the humectant used in the pre-wetting of the powder is triethylene glycol.

6. The method of claim 1, wherein the senor input received based on the pre-wetting the powder is a camera.

7. The method of claim 6, wherein the camera that provided the sensor input based on the pre-wetting of the powder is a high speed camera.

8. The method of claim 1, wherein the sensor input received based on the printing with the binders is a camera.

9. The method of claim 8, wherein the camera that provided the sensor input based on the printer with the binder is a high speed camera.

10. The method of claim 1, wherein the sensor input received based on the printing with the binder is an x-ray machine.

11. The method of claim 10, wherein the x-ray machine that provided the sensor input data based on the printing with the binder is a high speed x-ray machine.

12. The method of claim 1, further comprises:
performing adjustments by the binder jetting printer according to the sensor input received based on the pre-wetting of the powder.

13. The method of claim 12, wherein the adjustments made by the binder jetting printer includes changing the output of liquid dispensed onto the powder.

14. The method of claim 12, wherein the adjustments made by the binder jetting printer includes decreasing the time between pre-wetting and printing.

15. The method of claim 12, wherein the adjustments made by the binder jetting printer includes increasing the time between pre-wetting and printing.

16. The method of claim 1, further comprises:
Performing adjustments by the binder petting printer according to the sensor input received based on the printing with the binder.

17. The method of claim 16, wherein the adjustments made by the binder jetting printer includes decreasing the spacing of the binder droplets.

18. The method of claim 16, wherein the adjustments made by the binder jetting printer includes increasing the spacing of the binder droplets.

19. The method of claim 1, further comprises:
post-procedure imaging.

20. The method of claim 19, wherein the post-procedure imaging is done by a scanning electron microscope.
